(19) United States
(12) Patent Application Publication
(10) Pub. No.: US 2026/0307571 A1
(43) Pub. Date: Oct. 8, 2026

(54) VEHICLE HAVING RAMP APPARATUS

(71) Applicants: Hyundai Motor Company, Seoul (KR); Kia Corporation, Seoul (KR)

(72) Inventors: Hyo Seop Cha, Hwaseong-si (KR); Seung Min Kang, Hwaseong-si (KR)

(21) Appl. No.: 19/239,507

(22) Filed: Jun. 16, 2025

(30) Foreign Application Priority Data
Apr. 2, 2025 (KR) 10-2025-0042699

(51) Int. Cl. B60P 1/43; B62D 21/03; B62D 25/02; B62D 25/20; B62D 27/06; A61G 3/06; B62D 21/15

(52) U.S. Cl. CPC B60P 1/43; B62D 21/03; B62D 25/025; B62D 25/2036; B62D 27/065; A61G 3/061; B62D 21/157

(57) ABSTRACT

Provided is a vehicle equipped with a ramp apparatus for assisting in boarding and disembarking of a wheelchair. The vehicle includes a plurality of cross members connecting a pair of side sills spaced apart from each other, a floor panel coupled to the pair of side sills and having a recess portion formed concavely downward, and at least one reinforcing cross member installed on the floor panel and having both ends coupled to the side sills, respectively.

### CROSS-REFERENCE TO RELATED APPLICATIONS

This application claims benefit of priority to Korean Patent Application No. 10-2025-0042699 filed on Apr. 2, 2025 in the Korean Intellectual Property Office, the disclosure of which is incorporated herein by reference in its entirety.

### TECHNICAL FIELD

The present disclosure relates to a vehicle equipped with a ramp apparatus for assisting in boarding and disembarking of a wheelchair.

### BACKGROUND

Buses, or specialized vehicles for disabled wheelchair users, often include a ramp apparatus assisting in the boarding and disembarking of a disabled person in a wheelchair. The ramp apparatus is equipped with a platform that is stored in the vehicle body, and the platform is configured to be tilted at a certain incline with respect to the ground by being deployed from the vehicle body to the ground, manually by the user or automatically by the motor.

Vehicles that use a motor as a driving source, such as hybrid vehicles or electric vehicles, use a high-voltage battery or the like as an energy source for driving the motor, and a battery module including multiple battery cells is mounted on the vehicle body at the bottom of the vehicle. In this case, if a wheelchair ramp apparatus is mounted on the vehicle, the ramp apparatus interferes with the layout of the battery module because it is mainly mounted on the bottom of the vehicle, and cannot be applied.

To prevent this issue, if the ramp apparatus is disposed on the floor panel of the vehicle, the step height increases, making it inconvenient for passengers to get on and off. In addition, if the ramp apparatus and floor panel are lowered and disposed together, the skeletal structure of the vehicle body is disconnected, which reduces rigidity and makes it difficult to disperse collision energy, and thus it is vulnerable to side collisions,

### SUMMARY

An aspect of the present disclosure is to provide a vehicle in which a ramp apparatus may be installed without interference with the layout of a battery module.

An aspect of the present disclosure is to provide a vehicle in which rigidity of the vehicle body and support for side collisions may be reinforced.

According to an aspect of the present disclosure, a vehicle may include a plurality of cross members connecting a pair of side sills spaced apart from each other; a floor panel coupled to the pair of side sills and having a recess portion formed concavely downward; and at least one reinforcing cross member installed on the floor panel and having both ends coupled to the side sills, respectively.

The vehicle may further include a ramp apparatus mounted within the recess portion on the floor panel.

The side sills may include a side sill inner panel; a side sill outer reinforcement having one side coupled to the side sill inner panel; a side sill outer panel coupled to the other side of the side sill outer reinforcement; and a reinforcing side member connected to a side of the side sill inner panel opposite to the side sill outer reinforcement.

The reinforcing side member may be formed of an extruded material to have at least one closed cross-section.

The reinforcing side member may be bolted together with the floor panel, the reinforcing cross member and the ramp apparatus.

The side sills may further include a side sill extension interposed between the side sill inner panel and the reinforcing side member, and an inclined panel partially surrounding the reinforcing side member, and the side sill extension and the inclined panel may each have an upper end portion coupled to the floor panel and a lower end portion coupled to the side sill inner panel.

The plurality of cross members may include a pair of first cross members and a pair of second cross members, and the first cross members and the second cross members may be coupled to a lower surface of the floor panel.

The first cross members may be coupled to the ramp apparatus, and the recess portion may be located between the pair of first cross members and has a depth equal to a height of a housing of the ramp apparatus.

The second cross members may be spaced apart from the first cross members and may be disposed in parallel, and the pair of second cross members may connect reinforcing side members of the pair of side sills and form a quadrangular skeletal structure.

The vehicle may further include a plurality of inner side members provided between the pair of side sills and connecting the first cross members and the second cross members.

The plurality of inner side members may be connected to the lower surface of the floor panel, and the inner side members may be connected to a front side member or a rear side member of the vehicle.

The ramp apparatus may include a housing; and a plurality of reinforcing rails coupled to an upper surface of the housing.

The reinforcing rails may extend across the housing, and have ends protruding from the housing on both sides of the housing, and the ends on both sides may be bolted to the first cross members, so that the reinforcing rails connect the pair of first cross members.

A side wall of the housing may be provided with a mounting bracket having a bolt hole thereon, the first cross members may be provided with a plurality of bulkheads having bolt holes and spaced apart from each other, and the reinforcing rails, the mounting bracket, and the bulkheads may be bolted together to the floor panel.

The reinforcing rails may be connected to both inner side members arranged in series along a longitudinal direction of the vehicle and spaced apart from each other.

The ramp apparatus may include at least one channel portion formed on a lower surface of the housing and accommodating the reinforcing cross member.

The reinforcing cross member may be positioned within the recess portion on the floor panel and may be disposed parallel to the plurality of cross members.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a perspective view illustrating a main part of a vehicle according to an embodiment;

FIG. 2 is a side view of FIG. 1;

FIG. 3 is a perspective view in which a ramp apparatus and a seat rail in FIG. 1 are omitted;

FIG. 4 is a perspective view and an enlarged cross-sectional view illustrating part A of FIG. 3 cut away;

FIG. 5 is a perspective view of FIG. 1 seen from below;

FIG. 6 is a perspective view in which a battery in FIG. 5 is omitted;

FIG. 7 is a cross-sectional view taken along line B-B of FIG. 6;

FIG. 8 is a diagram illustrating the operating status of a ramp apparatus;

FIG. 9 is a perspective view illustrating a ramp apparatus;

FIG. 10 is an enlarged cross-sectional view illustrating part C of FIG. 1; and

FIG. 11 is a perspective view of FIG. 9 seen from below.

### DETAILED DESCRIPTION OF ILLUSTRATIVE EMBODIMENTS

Hereinafter, the present disclosure will be described in detail through example drawings. With regards to reference numerals of components of respective drawings, it should be noted that the same components are given the same numerals as much as possible even if they are illustrated in different drawings.

In this specification, a vehicle refers to various vehicles that move a transported object such as a person, an animal, or an object from a starting point to a destination. Such vehicles are not limited to vehicles that run on roads or tracks.

In this specification, for the convenience of explanation, the present disclosure is described using a vehicle having a motor that receives power from a battery, such as a hybrid vehicle or an electric vehicle, as an example, but the present disclosure is not necessarily limited thereto.

In this specification, the terms first, second, etc. may be used to describe various components, but these components are not limited in terms of order, size, location, or importance by the terms first, second, etc., and are named only for the purpose of distinguishing one component from another.

In this specification, the terms “on,” “below,” “upper,” “lower,” “left and right,” “inner,” “outer,” “front,” “rear,” etc. used in relation to direction are defined based on the vehicle or body.

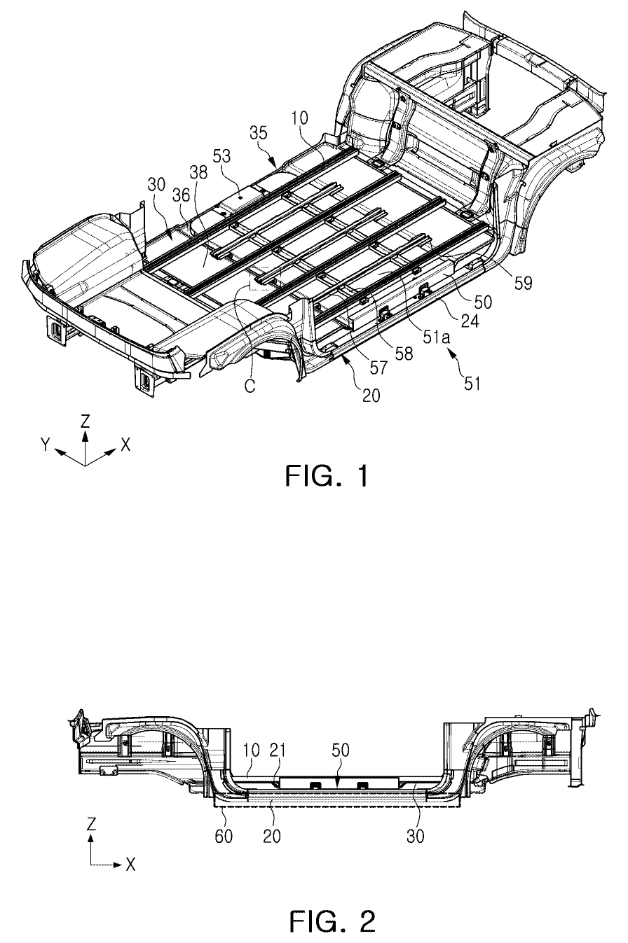

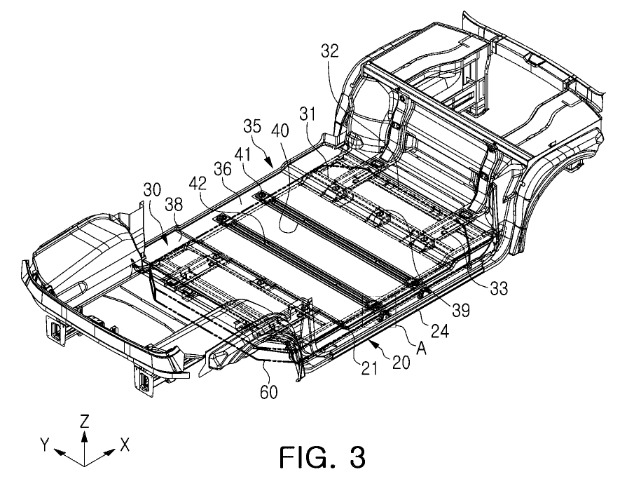

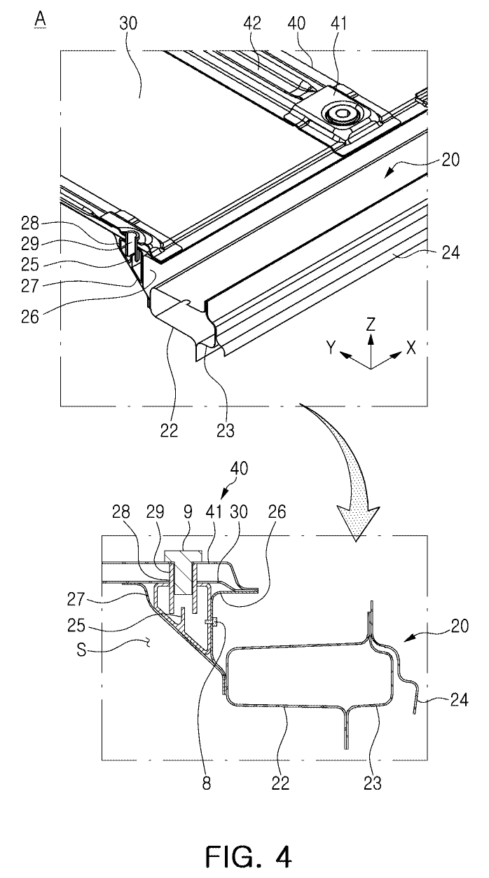

FIG. 1 is a perspective view illustrating a main part of a vehicle according to an embodiment, and FIG. 2 is a side view of FIG. 1. FIG. 3 is a perspective view of FIG. 1 in which a ramp apparatus and a seat rail are omitted, and FIG. 4 is a perspective view and an enlarged cross-sectional view illustrating part A of FIG. 3 cut away.

As illustrated in FIGS. 1 to 4, a vehicle according to an embodiment may include a floor panel 30, a plurality of cross members 31 and 32, at least one reinforcing cross member 40, and a ramp apparatus 50.

The vehicle may include a vehicle body, and the vehicle body may be manufactured in various shapes and sizes. The skeletal structure of the vehicle body may be composed of a pair of side sills 20 extending in the longitudinal direction (X) of the vehicle and forming a side surface of the vehicle body, and a plurality of cross members 31 and 32 extending in the width direction (Y) of the vehicle and coupled to both side sills 20.

A pair of side sills 20 may be disposed on the left and right sides of the lower portion of the vehicle body, and the pair of side sills 20 may be spaced apart from each other along the width direction (Y) of the vehicle. These side sills 20 may perform the function of protecting the passenger space in the event of a side collision of the vehicle while forming the appearance of the vehicle side.

At least one of the pair of side sills 20 may have a concave portion 21 in which the upper surface is formed lower than the surroundings in the middle portion. The concave portion may be located below a door (not illustrated) of the vehicle. The space created by the concave portion may be used for a platform 52 (see FIG. 8) of the ramp apparatus 50 to enter and move.

The side sill 20 may include a side sill inner panel 22, a side sill outer reinforcement 23, and a side sill outer panel 24.

The side sill inner panel 22 may be joined to one side of the side sill outer reinforcement 23. The side sill outer reinforcement 23 may be joined to the side sill inner panel 22 to form a closed section. By forming a closed section, the rigidity of the side sill 20 may be reinforced, so that the collision load may be attenuated when the vehicle is lateral-collided.

The side sill outer panel 24 may be joined to the other side of the side sill outer reinforcement 23.

The side sill 20 may be joined as a single piece by welding the side sill inner panel 22, the side sill outer reinforcement 23, and the side sill outer panel 24 in three layers on the lower end portion or upper end portion thereof.

In addition, the upper end portion or lower end portion of the side sill 20 may be processed by a sealer (not illustrated) in the longitudinal direction (X) of the vehicle to form sealing.

In a vehicle according to an embodiment, each side sill 20 may further include a reinforcing side member 25 connected to the side sill inner panel 22, a side sill extension 26 interposed between the side sill inner panel 22 and the reinforcing side member 25, and an inclined panel 27 surrounding the reinforcing side member 25.

The reinforcing side member 25 may be formed by extrusion using, for example, aluminum or an aluminum alloy as a material. The reinforcing side member 25 may have at least one closed section, or may have a bulkhead structure inside to have a plurality of closed sections. The plurality of closed sections supplements the support stiffness of the reinforcing side member 25 itself, and enables the reinforcing side member 25 to directly receive and withstand impact when the vehicle is hit from the side.

The reinforcing side member 25 may be connected to the inner surface of the side sill inner panel 22 in the width direction (Y) of the vehicle, for example, the surface thereof opposite to the side sill outer reinforcement 23, via the side sill extension 26.

This reinforcing side member 25 may reinforce the rigidity of the side sill 20 whose cross-sectional size in the vertical direction (for example, in the height direction (Z) of the vehicle) is reduced due to the concave portion 21. In addition, the reinforcing side member 25 may support the deformation of the side sill inner panel 22 inward in the width direction (Y) of the vehicle when the vehicle is subjected to a side collision, while absorbing the collision load by being deformed together with the side sill inner panel 22.

The reinforcing side member 25 may secure rigidity not only for the impact energy acting in the lateral direction of the side sill 20, but also for the impact energy acting in the longitudinal direction (X) of the vehicle.

By the reinforcing side member 25 being configured and disposed in this way, the amount of the side sill 20 introduced inwardly may be minimized in the event of a side collision of the vehicle, so that the vehicle has the advantage of being able to protect passengers as safely as possible.

In the vehicle according to an embodiment, the reinforcing side member 25 of the side sill 20 may be bolted to the floor panel 30, the reinforcing cross member 40, and the ramp apparatus 50.

To connect the reinforcing side member 25 with the floor panel 30, the reinforcing cross member 40, and the ramp apparatus 50, the reinforcing side member may be equipped with a pipe nut 29.

A through-hole 28 may be formed in the upper surface of the reinforcing side member 25, to which a pipe nut 29 may be fitted and welded, but the present disclosure is not necessarily limited thereto, and the reinforcing side member 25 and the pipe nut may 29 be formed integrally.

The pipe nut 29 is a member for fastening the floor panel 30, the reinforcing cross member 40, and the ramp apparatus 50 together to the reinforcing side member 25 by a bolt 9. This pipe nut 29 is installed on the reinforcing side member 25 and may be disposed to protrude from the upper surface of the reinforcing side member 25. A hollow screw hole may be formed in the pipe nut 29 in the longitudinal direction thereof.

The pipe nut 29 may penetrate the floor panel 30 and reach the inner surface of the mounting portion 41 provided on the reinforcing cross member 40. Next, the bolt 9 inserted inside the ramp apparatus 50 may be inserted and fastened to the pipe nut 29 by sequentially penetrating a lower case 51b of the ramp apparatus 50, the mounting portion 41 of the reinforcing cross member 40, and the floor panel 30.

At this time, a tool hole 55 into which a tool may be inserted for tightening the bolt 9 may be formed in the upper surface of an upper case 51a constituting a housing 51 of the ramp apparatus 50.

The side sill extension 26 may be formed of a plate having a cross-sectional shape bent into an inverted L shape. The lower end portion of the side sill extension 26 may be joined to the side sill inner panel 22 by welding such as spot welding.

In this case, the reinforcing side member 25 formed of an extruded material is formed of a different material from that of the side sill inner panel 22 or the side sill extension 26, and thus, they cannot be directly connected to each other by joining such as spot welding.

Accordingly, the reinforcing side member 25 may be substantially connected to the side sill inner panel 22 and the side sill 20 by being coupled to the side sill extension 26 by a hetero material joining member 8, such as a flow drill screw (FDS) or the like, for example.

In addition, the upper end portion of the side sill extension 26 formed horizontally by folding may be joined to the lower surface of the floor panel 30 by welding, such as spot welding.

The inclined panel 27 may partially surround the reinforcing side member 25 from the inside in the width direction (Y) of the vehicle while connecting the side sill 20 and the floor panel 30.

The upper end portion of the inclined panel 27 formed horizontally by folding may be joined to the lower surface of the floor panel 30 by welding, such as spot welding, and the lower end portion of the inclined panel formed vertically by folding may be joined to the outer side surface of the side sill inner panel 22 by welding, such as spot welding.

In addition, adhesive is applied to the outer surface of the inclined surface provided on the reinforcing side member 25, so that the inclined panel 27 and the reinforcing side member may be joined.

The side sill extension 26 and the inclined panel 27 may form an additional side sill located further inwardly in the width direction (Y) of the vehicle than the side sill 20.

Therefore, the side sill 20 may be coupled to the floor panel 30 and installed on the vehicle body via the reinforcing side member 25, the side sill extension 26, and the inclined panel 27.

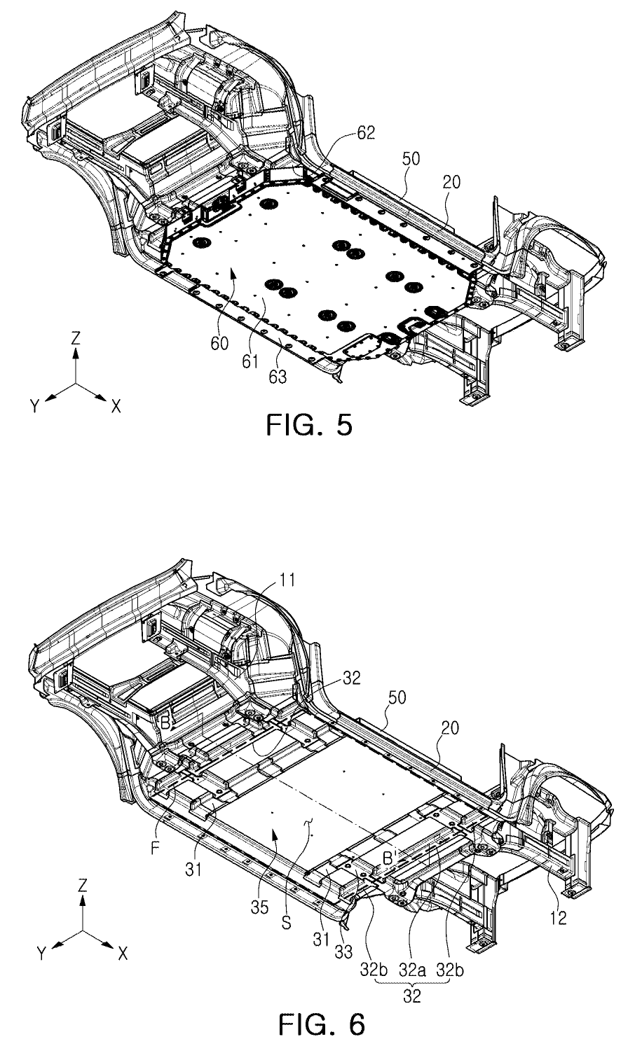

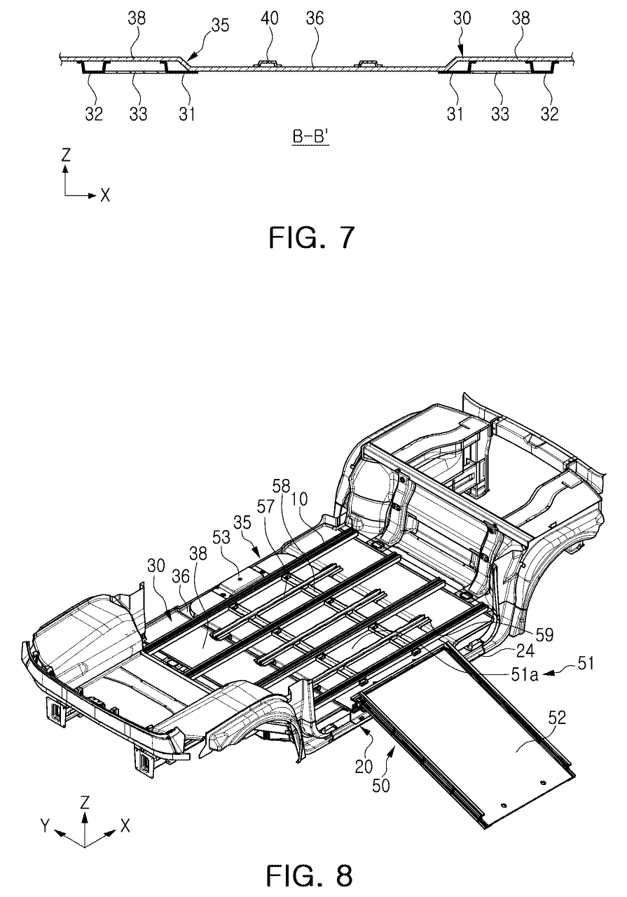

FIG. 5 is a perspective view of FIG. 1 as viewed from below, FIG. 6 is a perspective view illustrating FIG. 5 with the battery omitted, and FIG. 7 is a cross-sectional view taken along line B-B of FIG. 6.

Referring to FIGS. 5 to 7, a vehicle according to an embodiment may include a battery module 60 disposed in the middle thereof in the longitudinal direction (X) and the lower portion thereof in the height direction (Z) of the vehicle. A battery space (S) in which the battery module is mounted may be provided in the vehicle body.

For example, the battery module 60 may include one or more battery cells capable of being charged and discharged, a battery case 61 that accommodates the battery cells, and a cover 62 that covers the upper portion of the battery case. Because the configuration of the battery module is already widely known, a detailed description of the configuration of the battery module is omitted in this specification, and the battery module is described and illustrated as a single component.

A floor panel 30 may be installed above the battery space (S). In detail, the battery module 60 may be mounted on a pair of side sills 20 to be disposed below the floor panel 30.

In detail, for example, side flanges 63 may be provided on both sides of the battery case 61, respectively, and each side flange 63 is coupled to the lower surface of the side sill inner panel 22 of the corresponding side sill 20 through bolting or the like, so that the battery module 60 may be mounted on a pair of side sills.

A plurality of cross members 31 and 32 may be coupled to the side surface of the side sill 20 (for example, the inclined surface of the inclined panel 27) and the lower surface of the floor panel 30 at intervals from the front end to the rear end of the vehicle body.

The plurality of cross members may include a pair of first cross members 31 and a pair of second cross members 32, which are distinguished depending on whether or not they are coupled to the ramp apparatus 50 or positions thereof.

The first cross member 31 may be disposed adjacent to the ramp apparatus so that the ramp apparatus 50 may be coupled. The second cross member 32 may be spaced outwardly from the ramp apparatus and the first cross member along the longitudinal direction (X) of the vehicle and disposed parallel to the first cross member.

The plurality of cross members 31 and 32 may each be formed as a member formed of a single plate having a cross-sectional shape that is bent or curved to have an open cross-section, for example, or a member formed by joining two or more plates in the longitudinal direction thereof, for example, in the width direction (Y) of the vehicle. However, the present disclosure is not necessarily limited thereto, and the cross member may be provided as a tubular member having a hollow portion therein and a cross-sectional shape of a polygon having four or more corners.

For example, the first cross member 31 may have an open cross-section having an approximately L-shaped shape, and the second cross member 32 may have an open cross-section having an approximately U-shaped shape.

Optionally, first flange surfaces may be formed on both ends of the cross members 31 and 32 in the longitudinal direction, for example, on both ends thereof in the width direction (Y) of the vehicle. Each first flange surface may be inclined corresponding to the inclined surface of the inclined panel 27 of the side sill 20. The first flange surface may be joined to the outer surface of the inclined surface of the inclined panel 27 by welding, such as spot welding, laser welding, or arc welding using carbon dioxide or the like.

In addition, a second flange surface may be formed on edges extended along the longitudinal direction of the cross members 31 and 32 to connect the cross members to the floor panel 30. The second flange surface may be joined to the lower surface of the floor panel 30 by welding, such as spot welding, laser welding, or arc welding using carbon dioxide or the like.

These plurality of cross members 31 and 32 may reinforce the rigidity of the vehicle body against the collision load entering in the longitudinal direction of the cross member due to the folded cross-sectional shape of the cross members.

Furthermore, the reinforcing side members 25 of a pair of side sills 20 and a pair of second cross members 32 connecting these reinforcing side members may form a quadrangular skeletal structure (F). A pair of first cross members 31 are disposed within the quadrangular skeletal structure, so that the skeletal structure may be further strengthened.

This quadrangular skeletal structure (F) increases the rigidity of the vehicle body and acts as a load path that transmits the collision load when the vehicle collides, thereby responding to the collision and reducing the deformation of the vehicle body.

The vehicle body may further include a plurality of inner side members 33 that extend in the longitudinal direction (X) of the vehicle, between a pair of side sills 20, and connect the first cross member 31 and the second cross member 32.

Each of the plurality of inner side members 33 may be formed of a single plate having a cross-sectional shape that is bent or curved to have an open cross-section, for example, but is not necessarily limited thereto. For example, each inner side member 33 may have an open cross-section having an approximately U-shaped shape.

For example, based on the ramp apparatus 50, a pair of inner side members 33 may be positioned on one side of the ramp apparatus, and another pair of inner side members 33 may be positioned on the other side of the ramp apparatus 50.

The inner side member 33 on one side of the ramp apparatus 50 and the inner side member 33 on the other side of the ramp apparatus may be aligned along the longitudinal direction (X) of the vehicle, but are not connected to each other. In detail, the ramp apparatus 50 may be positioned between the inner side members 33 aligned along the longitudinal direction of the vehicle.

When the vehicle is subjected to a side collision, the collision load transmitted to the cross members 31 and 32 is transmitted to the corresponding inner side members 33 mechanically connected to the cross members, and may be distributed along the inner side members in the longitudinal direction (X) of the vehicle. Therefore, the inner side members 33 may increase the durability and rigidity of the vehicle body, thereby minimizing deformation of the vehicle body during a side collision.

For example, when one side of the vehicle in the longitudinal direction (X) is referred to as the front and the other side thereof in the longitudinal direction is referred to as the rear, for distinction, the vehicle body may include a pair of front side members 11 extended from a second cross member 32 on one side and a pair of rear side members 12 extended from a second cross member on the other side.

In this case, the inner side member 33 on one side may be aligned and connected to the front side member 11 in the longitudinal direction (X) of the vehicle, and the inner side member 33 on the other side may be aligned and connected to the rear side member 12 in the longitudinal direction of the vehicle.

Optionally, a first flange surface may be formed on one end of the inner side member 33 in the longitudinal direction (for example, in the longitudinal direction (X) of the vehicle). The first flange surface may be joined to the lower surface of the first cross member 31 by welding, such as spot welding, laser welding, arc welding using carbon dioxide or the like.

In addition, a second flange surface may be formed on edges extended along the longitudinal direction of the inner side member 33 (for example, the longitudinal direction (X) of the vehicle) to connect the inner side member to the floor panel 30. The second flange surface may be joined to the lower surface of the floor panel by welding, such as spot welding, laser welding, arc welding using carbon dioxide or the like.

In the case where the vehicle body includes a plurality of inner side members 33, the second cross member 32 among the cross members may include one middle portion 32a and a pair of split portions 32b spaced apart from each other on both sides of the middle portion in the longitudinal direction thereof.

A first flange surface may be formed on both ends of the middle portion 32ain the longitudinal direction (for example, the width direction (Y) of the vehicle). Each first flange surface may be joined to the lower surface of the inner side member 33 by welding, such as spot welding, laser welding, arc welding using carbon dioxide or the like.

In addition, a second flange surface may be formed on edges extended along the longitudinal direction of the middle portion 32a (for example, the width direction (Y) of the vehicle) to connect the middle portion to the floor panel 30. The second flange surface may be joined to the lower surface of the floor panel 30 by welding, such as spot welding, laser welding, arc welding using carbon dioxide or the like.

A first flange surface may be formed on both ends of each split portion 32b in the longitudinal direction (for example, the width direction (Y) of the vehicle). The first flange surface on one side may be joined to the inclined surface of the inclined panel 27 of the side sill 20, and the first flange surface on the other side may be joined to the lower surface of the inner side member 33 by welding, such as spot welding, laser welding, arc welding using carbon dioxide or the like.

Likewise, a second flange surface may be formed on edges extended along the longitudinal direction of each split portion 32b (for example, the width direction (Y) of the vehicle) to connect the split portion to the floor panel 30. The second flange surface may be joined to the lower surface of the floor panel 30 by welding, such as spot welding, laser welding, arc welding using carbon dioxide or the like.

The floor panel 30 may be disposed between a pair of side sills 20. The floor panel may partition a passenger space where passengers board.

In detail, the floor panel 30 may be joined to the side sills 20 by welding, for example, at least the left and right edges of the floor panel 30 to the side sill extensions 26 of respective side sills 20.

In addition, the floor panel 30 may be placed on the first cross member 31, the second cross member 32, and the inner side member 33, and may be coupled to the first cross member 31, the second cross member 32, and the inner side member 33 by welding and/or bolting, or the like.

In a vehicle according to an embodiment, the floor panel 30 may include a recess portion 35 that is concavely formed downward. The recess portion 35 may be positioned between a pair of first cross members 31.

The floor panel 30 having the recess portion 35 may be formed of a metal material such as steel, for example, and may be formed by forming using a press, bending, roll forming, or combinations thereof, or the like.

The recess portion 35 may have a cross-sectional shape that is approximately U-shaped or an inverted trapezoid. By this recess portion 35, the floor panel 30 may be formed stepwise along the longitudinal direction (X) of the vehicle.

For convenience of explanation, the bottom surface of the recess portion 35 is referred to as the first flat surface 36, and the upper surface of the floor panel 30 other than the recess portion is referred to as the second flat surface 38. The floor panel 30 may have one first flat surface 36 and one pair of second flat surfaces 38 due to a two-stepped shape thereof.

The recess portion 35 may have a depth equal to or deeper than the depth of the concave portion 21 formed in the side sill 20. In addition, the recess portion may have a depth equal to the height of the housing 51 of the ramp apparatus 50.

Therefore, the ramp apparatus 50 may be stably installed in the recess portion 35, and the ramp apparatus 50 is not interfered with or hindered during operation.

At least one reinforcing cross member 40 is installed on the floor panel 30, and both ends thereof may be coupled to the side sills 20 respectively. This reinforcing cross member 40 may extend across the floor panel 30 along the width direction (Y) of the vehicle on the first flat surface 36 in the recess portion 35 of the floor panel. In detail, the reinforcing cross member 40 may be disposed on the floor panel 30, between the pair of first cross members 31 and parallel to the first cross members 31.

The reinforcing cross member 40 may be formed as a single plate having a cross-sectional shape that is bent or curved to have an open cross-section, for example. However, the present disclosure is not necessarily limited thereto, and the reinforcing cross member 40 may also be provided as a tubular member having a hollow portion therein and a cross-sectional shape of a polygon having four or more corners.

For example, the reinforcing cross member 40 may have an open cross-section of an approximately inverted U shape.

Optionally, a flange surface may be formed on edges extended along the longitudinal direction (for example, the width direction (Y) of the vehicle) of the reinforcing cross member 40 to connect the reinforcing cross member 40 to the floor panel 30. As a result, the reinforcing cross member 40 may have a hat-shaped cross-sectional shape. The flange surface may be joined to the upper surface of the floor panel 30 by welding, such as spot welding, laser welding, or arc welding using carbon dioxide or the like.

In addition, mounting portions 41 having a bolt hole may be provided on both ends of the longitudinal direction (for example, the width direction (Y) of the vehicle) of the reinforcing cross member 40. Through these mounting portions 41, the ramp apparatus 50 may be coupled to the reinforcing side member 25 of the side sill 20.

For example, the mounting portions 41 may be formed with a different cross-sectional shape and/or a different material from that of the reinforcing cross member 40. The mounting portions 41 may be formed separately and then joined to the reinforcing cross member 40 by, for example, welding, but is not necessarily limited thereto.

As described above, the bolt 9 inserted inside the ramp apparatus 50 penetrates the mounting portion 41 of the reinforcing cross member 40 and is inserted and fastened to the pipe nut 29 provided on the reinforcing side member 25 of the side sill 20, so that the reinforcing cross member 40 is coupled to the side sill 20 together with the floor panel 30, and the ramp apparatus 50 may be firmly installed.

In summary, the reinforcing cross member 40 may be coupled to the floor panel 30 by welding, and at the same time, may be coupled to the side sill 20 by bolting, together with the floor panel 30. As a result, at least one reinforcing cross member 40 is disposed within the quadrangular skeletal structure (F) described above, so that the skeletal structure may be further strengthened.

The quadrangular skeletal structure (F) reinforced in this way increases the rigidity of the vehicle body, and acts as a load path that transmits the collision load when the vehicle collides, so that it may respond to the collision and reduce the deformation of the vehicle body.

Therefore, in a vehicle according to an embodiment, the ramp apparatus 50 may be coupled to the floor panel 30 via the mounting portion 41 of the reinforcing cross member 40 and may be connected and fixed to the vehicle body, for example, a pair of reinforcing side members 25.

In addition, a bead portion 42 extending along the longitudinal direction of the reinforcing cross member 40 (for example, the width direction (Y) of the vehicle) may be formed on the upper surface of the reinforcing cross member 40. The bead portion 42 may be formed as a concave channel or a convex protrusion.

The depth or height of the bead portion 42, for example, the depth of the channel or the height of the protrusion, may be variable, and the depth of the channel may become shallower or the height of the protrusion may become lower as it goes toward the end of the reinforcing cross member 40.

Accordingly, the middle portion of the reinforcing cross member 40 may have an approximately M-shaped cross-sectional shape, and the upper surface of both ends thereof may gradually become flat to show a simple hat-shaped cross-sectional shape.

In addition to the folded cross-sectional shape, by forming the bead portion 42, the reinforcing cross member 40 may reinforce the rigidity of the vehicle body against the collision load entering in the longitudinal direction of the reinforcing cross member (for example, the width direction (Y) of the vehicle).

In a case in which a side collision of a vehicle occurs, when the collision load input to the side sill 20 is transmitted to the reinforcing cross member 40, the reinforcing cross member 40 may play a role as a member supporting the collision load together with the plurality of cross members 31 and 32.

Therefore, the reinforcing cross member 40 may further improve the safety against the side collision, minimize the deformation of the vehicle body, the ramp apparatus 50, and the battery module 60 during the side collision, and protect the ramp apparatus 50 and the battery module 60.

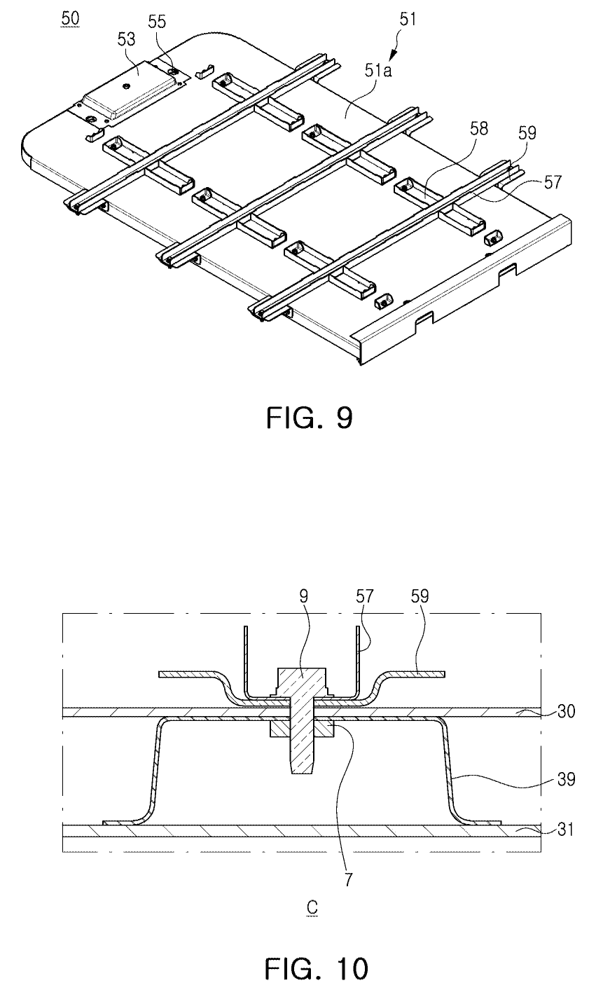

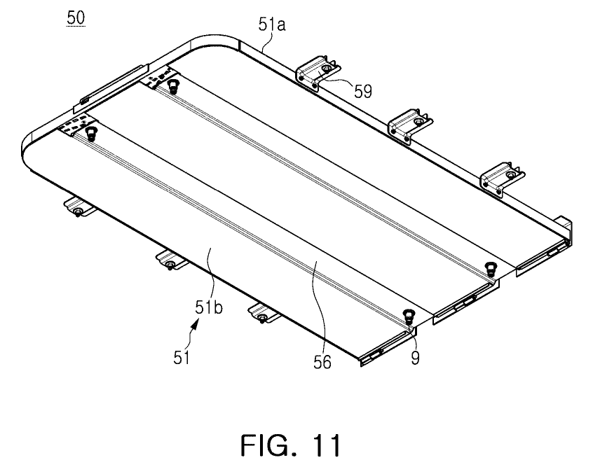

FIG. 8 is an operating state diagram of the ramp apparatus. FIG. 9 is a perspective view illustrating a ramp apparatus, FIG. 10 is a cross-sectional view illustrating an enlarged portion C of FIG. 1, and FIG. 11 is a perspective view of FIG. 9 viewed from below.

Referring to FIGS. 8 to 11, the ramp apparatus 50 may include a housing 51, a platform 52 that may move between a storage position within the housing 51 and a deployment position outside the housing 51, and a drive portion 53 that is installed in the housing 51 and applies driving force to the platform 52. The drive portion 53 may include a motor, a reducer, and the like.

In addition, the ramp apparatus 50 may further include a power transmission mechanism (not illustrated) that is interposed between the drive portion 53 and the platform 52 and transmits the driving force of the drive portion to the platform 52. As the power transmission mechanism, for example, a mechanism having a pair of sprockets and a chain, or a mechanism having a gear and a lead screw, or the like may be employed, but is not necessarily limited thereto.

The ramp apparatus 50 configured in this manner may be installed in the recess portion 35 of the floor panel 30 and fixedly coupled to the floor panel 30. When the driving force of the drive portion 53 is transmitted to the platform 52 via the power transmission mechanism, the platform 52 may be withdrawn from the housing 51 and placed in the deployed position with one end touching the ground. Then, when the drive portion 53 is operated in contrary, the platform 52 may be drawn into the housing and placed in the storage position.

In this specification, for the convenience of explanation, a more detailed description of the configuration and operation of the ramp apparatus 50 will be omitted. Instead, the description will focus on the coupling relationship between the ramp apparatus 50 and the vehicle body.

The housing 51 may accommodate components of the ramp apparatus, such as the platform 52, the drive portion 53, and the like. To this end, the housing 51 may be equipped with an upper case 51a and a lower case 51b.

The housing 51 may include a plurality of reinforcing rails 57 coupled to the upper surface of the upper case 51a, and a plurality of connecting rails 58 coupled to the upper surface of the upper case 51a on both sides of each reinforcing rail 57.

The reinforcing rail 57 may be formed of a single plate having a cross-sectional shape that is bent or curved to have an open cross-section, for example, but is not necessarily limited thereto. In practice, the reinforcing rail 57 may have an open cross-section having a shape of a roughly inverted hat.

In addition, the reinforcing rail 57 may have a length longer than the length of the width direction (for example, the longitudinal direction (X) of the vehicle) of the housing 51. Accordingly, the reinforcing rail 57 may extend across the housing 51, and furthermore, ends of the reinforcing rail 57 may protrude from the housing 51 in the longitudinal direction of the vehicle, on both sides of the housing 51.

The reinforcing rail 57 may be coupled to the upper surface of the upper case 51a by welding, such as spot welding.

The connecting rail 58 may be formed of a single plate having a cross-sectional shape that is folded or bent to have an open cross-section, for example, but is not necessarily limited thereto. For example, the connecting rail 58 may have an open cross-section having an approximately U-shaped shape.

A plurality of connecting rails 58 may be disposed symmetrically with respect to the corresponding reinforcing rail 57 on both sides of the reinforcing rail 57. In addition, a connecting rail corresponding to one reinforcing rail 57 may be spaced apart from a connecting rail corresponding to another reinforcing rail 57 by a predetermined distance. A seat rail 10 may be positioned in the space between these connecting rails later.

This connecting rail 58 may first be bolted to the upper surface of the upper case 51a to determine a joining position, and then may be joined to the upper surface of the upper case 51a by welding such as spot welding.

The plurality of reinforcing rails 57 may include at least pairs, for example, of two reinforcing rails 57. The drawings illustrate an example in which three reinforcing rails 57 are applied, but the number of reinforcing rails 57 is not necessarily limited thereto. The longitudinal (for example, longitudinal direction (X) of the vehicle) ends of each reinforcing rail 57 may be bolted to the first cross member 31.

To this end, a mounting bracket 59 having a cross-sectional shape bent in an inverted L shape and having bolt holes formed therein may be welded to both sidewalls of the upper case 51a. In addition, bolt holes may be formed in the longitudinal (for example, longitudinal direction (X) of the vehicle) ends of the reinforcing rail 57.

In addition, a plurality of bulkheads 39 may be provided at intervals from each other on the first cross member 31 for the connection of the reinforcing rail 57. Bolt holes may be formed in respective bulkheads 39. At least two bulkheads 39 may be positioned corresponding to the inner side members 33 on the first cross member 31.

As illustrated in FIG. 10, a bolt 9 inserted from the inner surface of the reinforcing rail 57 may penetrate the reinforcing rail 57, the mounting bracket 59, the floor panel 30, and the bulkhead 39 of the first cross member 31, and may be fastened to the nut 7.

For example, in the case where the vehicle body includes a pair of front side members 11 and a pair of rear side members 12 as described above, at least two reinforcing rails 57 are respectively connected to the inner side members 33 arranged in series on both sides along the longitudinal direction (X) of the vehicle and spaced apart from each other, thereby being aligned with the front side member 11 and the rear side member 12 between the pair of first cross members 31 and connecting the front side member 11 and the rear side member 12.

Accordingly, the plurality of reinforcing rails 57 connect the load path between the front side member 11 and the rear side member 12 that are disconnected due to the recess portion 35 of the floor panel 30 and the ramp apparatus 50, thereby dispersing and transmitting the collision load and reducing the deformation of the vehicle body when the vehicle collides.

Therefore, in the vehicle according to an embodiment, the ramp apparatus 50 may be coupled to the floor panel 30, and connected and fixed to the vehicle body, for example, to a pair of first cross members 31 and a plurality of inner side members 33, through the reinforcing rail 57 and the mounting bracket 59 fixed to the upper case 51a of the housing 51.

Above the housing 51 of the ramp apparatus 50, in detail, on the upper surface of the upper case 51a, a plurality of seat rails 10 (see FIG. 1) for installing the seat of the vehicle may be disposed to extend along the longitudinal direction (X) of the vehicle while crossing the housing 51 of the ramp apparatus 50, along with a plurality of reinforcing rails 57.

When the ramp apparatus 50 is settled in the recess portion 35 of the floor panel 30, the upper surface of the upper case 51a and the second flat surface 38 of the floor panel 30 may be placed on the same plane at the same height from the ground.

Then, the plurality of seat rails 10 are respectively positioned in the space between the aforementioned connecting rails 58 on the upper surface of the upper case 51a, and may be coupled to the upper surface of the upper case 51a by bolting via the rail mounting bracket provided on each seat rail 10. For example, rail mounting brackets having bolt holes may be welded to the outer side surfaces of both sides of the seat rail 10.

A plurality of seat rails 10 together with a plurality of reinforcing rails 57 and a plurality of connecting rails 58 may be disposed in a grid shape on the upper surface of the upper case 51a forming the housing 51 of the ramp apparatus 50. Accordingly, the ramp apparatus 50 may be firmly fixed to the floor panel 30, and the durability and rigidity of the vehicle body, which are disadvantaged due to the downward disposition of the ramp apparatus 50, may be supplemented, so that deformation of the vehicle body may be minimized in the event of a side collision.

In addition, the housing 51 may include at least one channel portion 56 formed on the lower surface of the lower case 51b to accommodate a reinforcing cross member 40.

The lower case 51b having the channel portion 56 may be formed of a metal material such as steel, for example, and may be formed by forming using a press, bending, roll forming, or combinations thereof.

The channel portion 56 may have a cross-sectional shape of an approximately inverted U. This channel portion 56 may protrude from the lower case 51binto the interior of the housing 51.

The channel portion 56 may have a depth that is at least equal to the height of the reinforcing cross member 40.

By accommodating the reinforcing cross member 40 disposed on the first flat surface 36 of the floor panel 30 within the channel portion 56 of the lower case 51b constituting the housing 51 of the ramp apparatus 50, the ramp apparatus 50 may be stably settled within the recess portion 35, and the ramp apparatus 50 may also be prevented from moving in the longitudinal direction (X) of the vehicle.

As described above, according to an embodiment of the present disclosure, the effect of installing a ramp apparatus without interference with the layout of the battery module is obtained.

In addition, according to an embodiment of the present disclosure, the effect of reinforcing the strength of the vehicle body and support for side collisions is obtained.

While example embodiments have been illustrated and described above, it will be apparent to those skilled in the art that modifications and variations could be made without departing from the scope of the present disclosure as defined by the appended claims.

What is claimed is:

1. A vehicle comprising:
a plurality of cross members connecting a pair of side sills spaced apart from each other;
a floor panel coupled to the pair of side sills and having a recess portion formed concavely downward; and
at least one reinforcing cross member installed on the floor panel and having both ends coupled to the pair of side sills, respectively.

2. The vehicle of claim 1, further comprising a ramp apparatus mounted within the recess portion on the floor panel.

3. The vehicle of claim 2, wherein each side sill of the pair of side sills includes:
a side sill inner panel;
a side sill outer reinforcement having a first side coupled to the side sill inner panel;
a side sill outer panel coupled to a second side of the side sill outer reinforcement; and
a reinforcing side member connected to a side of the side sill inner panel opposite to the side sill outer reinforcement.

4. The vehicle of claim 3, wherein the reinforcing side member is formed of an extruded material to have at least one closed cross-section.

5. The vehicle of claim 3, wherein the reinforcing side member is bolted together with the floor panel, the reinforcing cross member, and the ramp apparatus.

6. The vehicle of claim 3, wherein each side sill of the pair of side sills further includes:
a side sill extension interposed between the side sill inner panel and the reinforcing side member, and
an inclined panel partially surrounding the reinforcing side member,
wherein the side sill extension and the inclined panel each have an upper end portion coupled to the floor panel and a lower end portion coupled to the side sill inner panel.

7. The vehicle of claim 2, wherein:
the plurality of cross members includes a pair of first cross members and a pair of second cross members, and
the pair of first cross members and the pair of second cross members are coupled to a lower surface of the floor panel.

8. The vehicle of claim 7, wherein:
the pair of first cross members are able to be coupled to the ramp apparatus, and
the recess portion is located between the pair of first cross members and has a depth equal to a height of a housing of the ramp apparatus.

9. The vehicle of claim 7, wherein:
the pair of second cross members are spaced apart from the pair of first cross members and are disposed in parallel, and
the pair of second cross members connect reinforcing side members of the pair of side sills and form a quadrangular skeletal structure.

10. The vehicle of claim 7, wherein the vehicle further includes a plurality of inner side members provided between the pair of side sills and connecting the pair of first cross members and the pair of second cross members.

11. The vehicle of claim 10, wherein:
each of the plurality of inner side members are connected to the lower surface of the floor panel, and
the inner side members are connected to a front side member or a rear side member of the vehicle.

12. The vehicle of claim 10, wherein the ramp apparatus includes:
a housing; and
a plurality of reinforcing rails coupled to an upper surface of the housing.

13. The vehicle of claim 12, wherein the plurality of reinforcing rails extend across the housing, and have ends protruding from the housing on both sides of the housing, and
the ends on both sides are bolted to the first cross members, so that the plurality of reinforcing rails connect the pair of first cross members.

14. The vehicle of claim 13, wherein:
a side wall of the housing is provided with a mounting bracket having a bolt hole thereon,
the pair of first cross members are provided with a plurality of bulkheads having bolt holes and spaced apart from each other, and
the plurality of reinforcing rails, the mounting bracket, and the bulkheads are bolted together to the floor panel.

15. The vehicle of claim 13, wherein the plurality of reinforcing rails are connected to both inner side members of the plurality of inner side members arranged in series along a longitudinal direction of the vehicle and spaced apart from each other.

16. The vehicle of claim 12, wherein the ramp apparatus includes at least one channel portion formed on a lower surface of the housing and accommodating the at least one reinforcing cross member.

17. The vehicle of claim 1, wherein the at least one reinforcing cross member is positioned within the recess portion on the floor panel and is disposed parallel to the plurality of cross members.

18. A side sill of a vehicle, the side sill comprising:
a side sill inner panel;
a side sill outer reinforcement having a first side coupled to the side sill inner panel;
a side sill outer panel coupled to a second side of the side sill outer reinforcement; and
a reinforcing side member connected to a side of the side sill inner panel opposite to the side sill outer reinforcement,
wherein the reinforcing side member is bolted together with a floor panel, a reinforcing cross member, and a ramp apparatus of the vehicle.

19. The side sill of claim 18, wherein the side sill is connected to a second side sill by at least one cross member.

20. The side sill of claim 18, further comprising:
a side sill extension interposed between the side sill inner panel and the reinforcing side member, and
an inclined panel partially surrounding the reinforcing side member,
wherein the side sill extension and the inclined panel each have an upper end portion coupled to the floor panel and a lower end portion coupled to the side sill inner panel.
